(19) United States
(12) Patent Application Publication
(10) Pub. No.: US 2012/0002628 A1
(43) Pub. Date: Jan. 5, 2012

(54) TECHNIQUE FOR EFFICIENTLY ALLOCATING RESOURCES IN VOIP COMMUNICATION

(76) Inventors: Yong Ho Kim, Gyeonggi-do (KR); Ki Seon Ryu, Gyeonggi-do (KR); Jeong Ki Kim, Gyeonggi-do (KR)

(21) Appl. No.: 13/255,398

(22) PCT Filed: Mar. 15, 2010
(86) PCT No.: PCT/KR2010/001586

§ 371 Date: Sep. 8, 2011

Related U.S. Application Data
(60) Provisional application No. 61/159,809, filed on Mar. 13, 2009.

(51) Int. Cl. H04W 72/04

(52) U.S. Cl. 370/329

(57) ABSTRACT

Disclosed is a method for performing efficient scheduling for VoIP communication, and performing VoIP communication according to the schedule. A bandwidth size and a transmission interval for the transmission of a VoIP packet to be used during a talk spurt are set, and a bandwidth size to be used for the transmission of an SID packet during a silence period is set in VoIP communication. The bandwidth size to be used during the silence period can be set to the bandwidth required for the transmission of an SID packet. To divide the talk spurt and the silence period, a user equipment uses two types of CQICH code words, so that a base station therefore performs scheduling in an efficient manner.

### TECHNICAL FIELD

The following description relates to a VoIP communication technique, and more particularly, to a method for performing efficient scheduling for VoIP communication and performing the VoIP communication.

### BACKGROUND ART

In the following description, a signal transmission technique for preventing resource waste and malfunction of a base station in a broadband wireless access system is explained. In particular, a method for a mobile station, which uses VoIP (voice over internet protocol) service, to prevent resource waste during a silence period using CQICH code words of two types and malfunctions of a base station is described. For this, VoIP traffic is briefly described as follows.

First of all, VoIP traffic is characterized in being generated in a fixed size having a fixed cycle in VoIP codec. VoIP communication can be divided into a talk spurt, in which a call is in progress between users, and a silence period in which a user does not talk but listens to. And, the silence period occupies a normal call session over 50%.

In order to allocate a bandwidth differing in size to each of the talk spurt and the silence period, various types of codec are used. And, a representative one of the various types of codec is AMR (adaptive multi-rate) used by GSM (global system for mobile communication) and UMTS (universal mobile telecommunication system).

Since voice data is not generated in the silence period, if a bandwidth is allocated to the silence period, resources can be wasted. To prevent this, VoIP supports silence suppression. According to the silence suppression, a vocoder for generating VoIP traffic does not generate traffic during the silence period but periodically generates comfort noise to inform a counterpart user that a call keeps being maintained. For example, the vocoder using the AMR codec generates a packet having a fixed size in the call spurt once per 20 ms and generates the comfort noise per 160 ms.

Meanwhile, a broadband wireless access system (e.g., IEEE 802.16e) provides a scheduling scheme called ‘Extended rtPS (extended real-time polling service)’ or ‘ErtPS’ for VoIP traffic, which supports the silence suppression. According to this scheme, a base station periodically allocates a UL (uplink) bandwidth used for a bandwidth request or a data transmission. And, the base station does not change a size of UL allocation until receiving a bandwidth change request from a mobile station. Moreover, when a mobile station requests a bandwidth change, if a bandwidth request size is set to 0, a base station only allocates a bandwidth (unicast BR opportunity) amounting to a size enough to transmit a bandwidth request header or a BR header or does not allocate a bandwidth at all.

### DISCLOSURE OF THE INVENTION

### Technical Problem

According to the extended real-time polling service, as mentioned in the foregoing description, it is able to improve the efficiency of bandwidths. If a mobile station requests a resource using CQICH code word, a base station allocates a UL resource in accordance with a current maximum sustained traffic rate value. Yet, in the following description, 2 types of CQICH code word are provided. And, a method of using a resource more efficiently by limiting a UL bandwidth to an SID packet transmission region containing a general MAC header (GMH) or a compact header (CH) during a silence period using the provided 2 types of the CQICH code word is provided. Moreover, in the following description, a method of easily discriminating whether a CQICH code word received by a base station relates to an SID packet of a mobile station or a VoIP packet using 2 types of CQICH code word is provided.

### Technical Solution

To achieve these objects and other advantages and in accordance with the purpose of the invention, as embodied and broadly described herein, a method of allocating a resource, which is allocated to a mobile station by a base station performing VoIP communication with the mobile station, according to one embodiment of the present invention includes the steps of receiving a 1^{st} type CQICH codeword from the mobile station, allocating an uplink resource of a 1^{st} type bandwidth size to the mobile station in each 1^{st} type interval, receiving a 2^{nd} type CQICH codeword from the mobile station, and allocating an uplink resource of a 2^{nd} type bandwidth size to the mobile station, wherein the 1^{st} type bandwidth size, the 1^{st} type interval and the 2^{nd} type bandwidth size are previously set to a bandwidth size for VoIP packet transmission, a VoIP packet transmission interval and a bandwidth size for SID packet transmission, respectively.

Preferably, the 1^{st} type CQICH codeword is used in a talk spurt and the 2^{nd} type CQICH codeword is used in a silence period.

Preferably, if an interval for the SID packet transmission is not defined, the base station having received the 2^{nd} type CQICH codeword allocates the uplink resource of the 2^{nd} type bandwidth to the mobile station once only. On the contrary, if an interval for the SID packet transmission is not defined, the base station having received the 2^{nd} type CQICH codeword allocates the uplink resource of the 2^{nd} type bandwidth to the mobile station with the 1^{st} type interval.

Preferably, the 2^{nd} type interval is previously set as an interval for the SID packet transmission and the base station having received the 2^{nd} type CQICH codeword allocates the uplink resource of the 2^{nd} type bandwidth size to the mobile station with the 2^{nd} type interval.

To further achieve these and other advantages and in accordance with the purpose of the present invention, a method of performing VoIP communication, which is performed on a base station by a mobile station, according to another embodiment of the present invention includes the steps of transmitting a 1^{st} type CQICH codeword to the base station, transmitting a VoIP packet using an uplink resource of a 1^{st} type bandwidth size, the uplink resource allocated by the base station in each 1^{st} type interval, transmitting a 2^{nd} type CQICH codeword to the base station, and transmitting an SID packet by receiving an uplink resource of a 2^{nd} type bandwidth size, the uplink resource allocated by the base station, wherein the 1^{st} type bandwidth size, the 1^{st} type interval and the second type bandwidth size are previously set to a bandwidth size for VoIP packet transmission, a VoIP packet transmission interval and a bandwidth size for SID packet transmission, respectively.

Preferably, the 1^{st} type CQICH codeword is used in a talk spurt and the 2^{nd} type CQICH codeword is used in a silence period.

Preferably, if an interval for the SID packet transmission is not defined, the mobile station transmits the 2^{nd} type CQICH codeword to the base station for the SID packet transmission each time. On the contrary, if an interval for the SID packet transmission is not defined, the mobile station having transmitted the 2^{nd} type CQICH codeword transmits the SID packet by having the uplink resource of the 2^{nd} type bandwidth size allocated by the base station with the 1^{st} type interval.

Preferably, the 2^{nd} type interval is previously set as an interval for the SID packet transmission and the mobile station having transmitted the 2^{nd} type CQICH codeword transmits the SID packet by having the uplink resource of the 2^{nd} type bandwidth size allocated by the base station with the 2^{nd} type interval.

### Advantageous Effects

According to the foregoing embodiments of the present invention, 2 types of CQICH code word are provided. And, a resource can be more efficiently used by limiting a UL bandwidth to an SID packet transmission region containing a general MAC header (GMH) or a compact header (CH) during a silence period using the provided 2 types of the CQICH code word.

Moreover, it is able to easily discriminate whether a CQICH code word received by a base station relates to an SID packet of a mobile station or a VoIP packet using 2 types of CQICH code word.

### DESCRIPTION OF THE DRAWINGS

FIG. 1 is a diagram of a process for a mobile station to perform poling during a silence period in ErtPS.

FIG. 2 is a diagram for a 1-time allocation scheme according to one embodiment of the present invention.

FIG. 3 is a diagram for a 1^{st} suppression scheme according to one embodiment of the present invention.

FIG. 4 is a diagram for a 2^{nd} suppression scheme according to one embodiment of the present invention.

FIG. 5 is a diagram for configurations of mobile and base stations, in which embodiments of the present invention are implemented, according to another embodiment of the present invention.

### BEST MODE FOR INVENTION

First of all, the following embodiments correspond to combinations of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment.

In the description of the drawings, procedures or steps, which may cloud the gist of the present invention, are not described. And, procedures or steps, which can be understood by those on the same level of those skilled in the art, are not described as well.

In this disclosure, embodiments of the present invention are described centering on the data transmission/reception relations between a base station and a terminal. In this case, the base station is meaningful as a terminal node of a network which directly performs communication with the terminal. In this disclosure, a specific operation explained as performed by a base station can be performed by an upper node of the base station in some cases.

In particular, in a network constructed with a plurality of network nodes including a base station, it is apparent that various operations performed for communication with a terminal can be performed by a base station or other networks except the base station. In this case, ‘base station’ can be replaced by such a terminology as a fixed station, a Node B, an eNode B (eNB), an access point and the like. And, ‘mobile station (MS)’ can be replaced by such a terminology as a user equipment (UE), a subscriber station (SS), a mobile subscriber station (MSS), a mobile terminal, a terminal and the like.

A transmitting stage means a node for transmitting data or audio service, and a receiving stage means a node for receiving the data or audio service. Therefore, a terminal becomes a transmitting stage and a base station becomes a receiving stage, in uplink. Likewise, a terminal becomes a receiving stage and a base station becomes a transmitting stage, in downlink.

Meanwhile, a mobile station of the present invention can include a PDA (personal digital assistant), a cellular phone, a PCS (personal communication service) phone, a GSM (global system for mobile) phone, a WCDMA (wideband CMDA) phone, an MBS (mobile broadband system) phone or the like. Moreover, a mobile station can include one of a PDA, a hand-held PC, a notebook computer, a smart phone, a multimode-multiband (MB-MB) terminal and the like.

In this case, the smart phone is a mobile station provided with the advantages of a mobile communication terminal and a personal hand-held terminal. And, the smart phone can mean a mobile station in which such a personal hand-held terminal function as a scheduling management and the like and such a data communication function as a fax transmission/reception, an internet access and the like are integrated together. The MB-MB terminal has a built-in modem chip and is operable in a mobile internet system and other mobile communication systems (e.g., CDMA (code division multiple access) 2000 system, WCDMA (wideband CDMA system), etc.).

Embodiments of the present invention can be implemented using various means. For instance, embodiments of the present invention can be implemented using hardware, firmware, software and/or any combinations thereof.

In the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known to the public.

Embodiments of the present invention are supportable by standard documents disclosed in at least one of wireless access systems including IEEE 802 system, 3GPP system, 3GPP LTE system and 3GPP2 system. In particular, the steps or parts, which are not explained to clearly reveal the technical idea of the present invention, in the embodiments of the present invention can be supported by the above documents. Moreover, all terminologies disclosed in this document can be supported by at least one of P802.16-2004, P802.16e-2005, P802.16Rev2 and IEEE 802.16m documents which are the standards of IEEE 802.16 system.

In the following description, a preferred embodiment of the present invention is explained in detail with reference to the accompanying drawings. Detailed description disclosed together with the accompanying drawings is intended to explain not a unique embodiment of the present invention but an exemplary embodiment of the present invention.

In the following description, specific terminologies used for embodiments of the present invention are provided to help the understanding of the present invention. And, the use of the specific terminology can be modified into another form within the scope of the technical idea of the present invention.

As mentioned in the foregoing description, a method for a mobile station using VoIP service to prevent resource waste during a silence period and malfunction of a base station using 2 types of CQICH code word is explained as follows. For this, an extended real-time polling service scheme is described as follows.

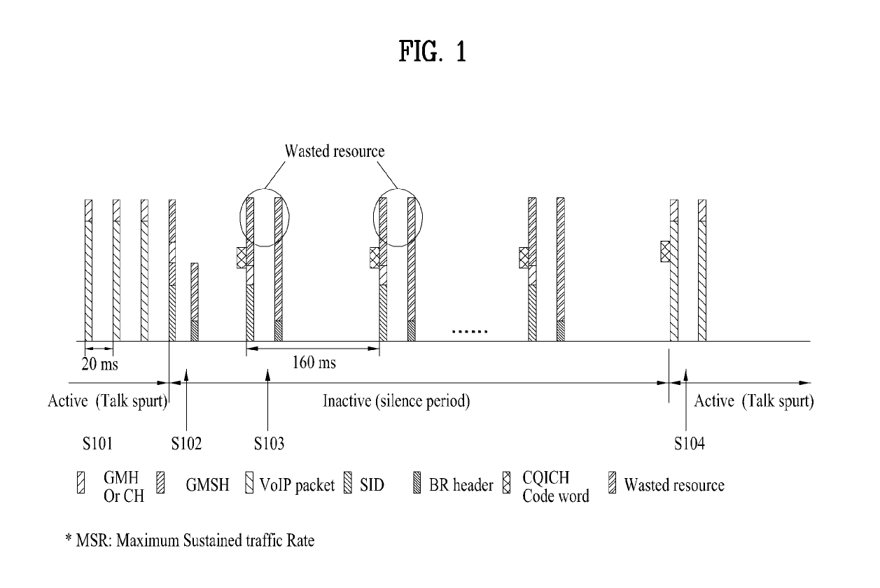

FIG. 1 is a diagram of a process for a mobile station to perform poling during a silence period in ErtPS.

As mentioned in the foregoing description, the extended real-time polling service is a scheme of supporting a real-time service flow for generating a data packet having a variable size periodically like the silence suppression in the VoIP service. In the step S101 shown in FIG. 1, a mobile station is able to periodically transmit VoIP packet containing a general MAC header (GMH) or a CM in a talk spurt. For this, a base station is able to perform a periodic UL resource allocation on the mobile station. And, the UL resource can be used for a bandwidth request and a data transmission. In this case, a size of the allocated resource can basically correspond to a maximum sustained traffic rate value.

If the mobile station makes a transition to a silence period from a talk spurt, it generates SID in stead of the VoIP packet. In the silence period, in order to change a size of a bandwidth allocated to the mobile station, the mobile station is able to make a change request to the base station using an extended piggyback request field of a grant management subheader (GMSH) or a bandwidth request (BR) field of a MAC signaling header [S102]. Moreover, the mobile station is able to make a change request to the base station by transmitting code word on CQICH [S103]. Having received the CQICH code word, the base station is able to allocate a UL resource in accordance with a current maximum sustained traffic rate value. Hence, a resource waste can be generated as indicated by the slash lines shown in FIG. 1.

Moreover, in case of using one CQICH code word, the base station has difficulty in determining whether the CQICH code word transmitted by the mobile station is for the SID packet or the VoIP packet. In particular, in the step S104, if the mobile station enters the talk spurt again and then transmits the CQICH code word for the VoIP packet, the base station has difficulty in identifying the CQICH code word.

Therefore, in the following description, 2 types of CQICH code word are provided and a VoIP communication scheme of a mobile station using the 2 types of the CQICH code word is explained, according to one embodiment of the present invention. The 2 types of CQICH provided according to the present embodiment are named a primary CQICH code word and a secondary CQICH code word.

Meanwhile, QoS parameters available for the present invention are described as follows.

Maximum sustained traffic rate per flow: Parameter indicating a maximum information rate of a service

Adaptation Method: Indicating an adaptive grant and polling service (aGPS) operation type

GPI_Primary: Primary grant and polling interval. This parameter is used as an interval for VoIP packet transmission in talk spurt in the following description.

GPI_Secondary: Secondary grant and polling interval. This parameter is used as an interval for SID packet transmission during a silence period in the following description.

GrantSize_Primary: Primary grant size. This parameter is used to indicate a UL bandwidth size for VoIP packet transmission in the following description.

GrantSize_Secondary: Secondary grant size. This parameter is used to indicate a UL bandwidth size for SID packet transmission in the following description.

The above-mentioned QoS parameters can be classified into primary parameters for the VoIP packet transmission in the talk spurt and secondary QoS parameters for the SID packet transmission in the silence period. Using the QoS parameters, the primary CQICH codeword and the secondary CQICH codeword are described as follows.

Primary CQICH Codeword

In case that a base station receives a primary CQICH codeword, the base station starts to transmit a UL grant in accordance with GrantSize_Primary or a current maximum sustained traffic rate value. In case that the base station receives the primary CQICH codeword in the silence period, the base station is able to change a current QoS parameter into a primary QoS parameter.

Secondary CQICH Codeword

In case that a base station receives a secondary CQICH codeword, the base station starts to transmit a UL grant in accordance with GrantSize_Secondary or an SID packet size. In case that the base station receives the secondary CQICH codeword in the talk spurt, the base station is able to change a current QoS parameter into a primary QoS parameter.

In the following description, various embodiments using the above-mentioned concept are explained.

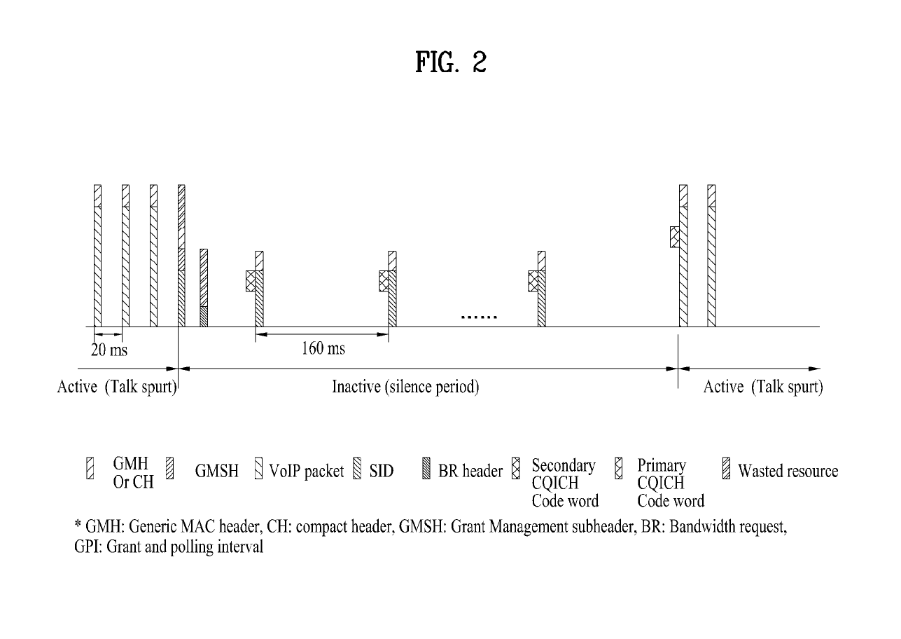

FIG. 2 is a diagram for a 1-time allocation scheme according to one embodiment of the present invention.

Referring to FIG. 2, assume that GPI_Primary, GrantSize_Primary and GrantSize_Secondary are set to 20 ms, VoIP packet size and SID packet size, respectively. Moreover, assume that GPI_Secondary is not defined in the embodiment shown in FIG. 2.

If a value of GPI_Secondary is not provided and an adaptation method is 1-time allocation scheme, a base station having received secondary CQICH codeword is proposed to allocate a UL resource based on GrantSize_Secondary once only. In particular, as shown in FIG. 2, a mobile station transmits a secondary CQICH codeword each time to transmit SID packet in UL. Having received the secondary CQICH codeword, a base station allocates a UL resource to each secondary CQICH codeword once only.

According to the present embodiment, in case that a base station receives a primary CQICH codeword (i.e., a mobile station having entered a talk spurt transmits a primary CQICH codeword), the base station is able to allocate a bandwidth having GrantSize_Primary size to GPI_Primary interval by changing a current QoS parameter into a primary QoS parameter.

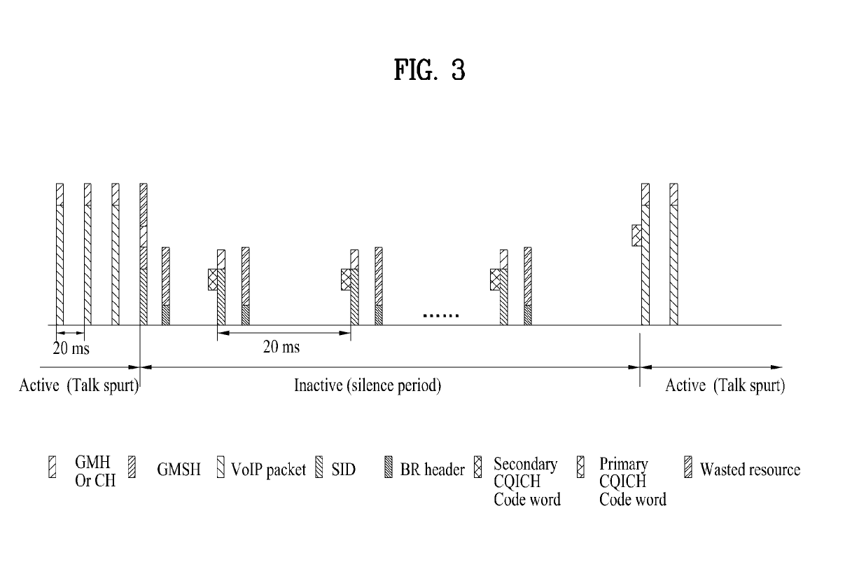

FIG. 3 is a diagram for a 1^{st} suppression scheme according to one embodiment of the present invention.

Referring to FIG. 3, according to the present embodiment, assume that GPI_Primary, GrantSize_Primary and GrantSize_Secondary are set to 20 ms, VoIP packet size and SID packet size, respectively. Moreover, assume that GPI_Secondary is not defined in the embodiment shown in FIG. 3.

If the GPI_Secondary is not defined and an adaptation method is a 1^{st} suppression scheme, a base station having received secondary CQICH codeword is able to allocate a bandwidth having a GrantSize_Secondary size with GPI_Primary to a mobile station.

According to the present embodiment, in case that a base station receives a primary CQICH codeword (i.e., a mobile station having entered a talk spurt transmits a primary CQICH codeword), the base station is able to allocate a bandwidth having GrantSize_Primary size in GPI_Primary interval by changing a current QoS parameter into a primary QoS parameter.

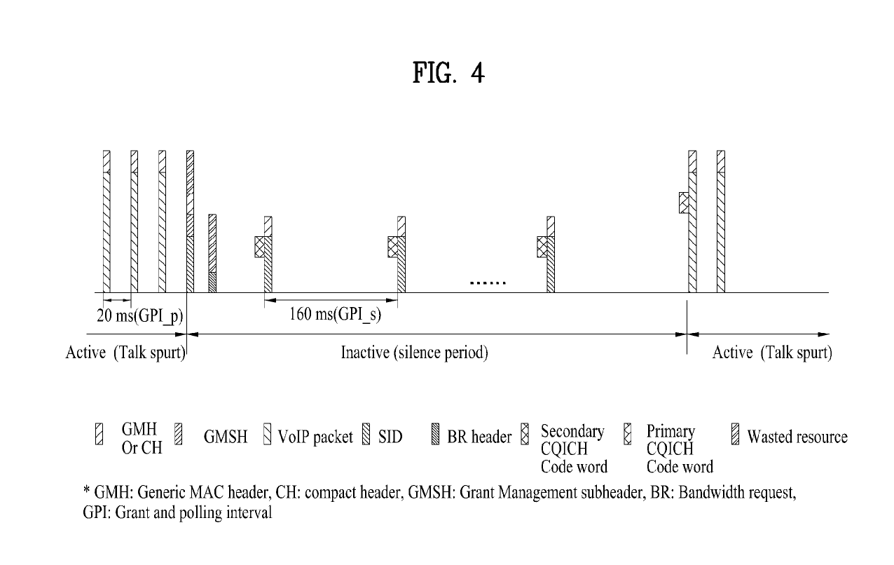

FIG. 4 is a diagram for a 2^{nd} suppression scheme according to one embodiment of the present invention.

Referring to FIG. 4, according to the present embodiment, assume that GPI_Primary, GPI_Secondary, GrantSize_Primary and GrantSize_Secondary are set to 20 ms, 160 ms, VoIP packet size and SID packet size, respectively.

If the GPI_Secondary is defined and an adaptation method is a 2^{nd} suppression scheme, a base station having received secondary CQICH codeword is able to continuously allocate a bandwidth having a GrantSize_Secondary size in GPI_Secondary interval to a mobile station.

According to the present embodiment, in case that a base station receives a primary CQICH codeword (i.e., a mobile station having entered a talk spurt transmits a primary CQICH codeword), the base station is able to allocate a bandwidth having GrantSize_Primary size in GPI_Primary interval by changing a current QoS parameter into a primary QoS parameter.

Thus, using 2 types of CQICH codeword and QoS parameters of 2 kinds of categories, bandwidth waste in the silence period can be prevented and operations of a base station can be further clarified.

In the following description, a method and apparatus for communication using the above-described schemes are explained.

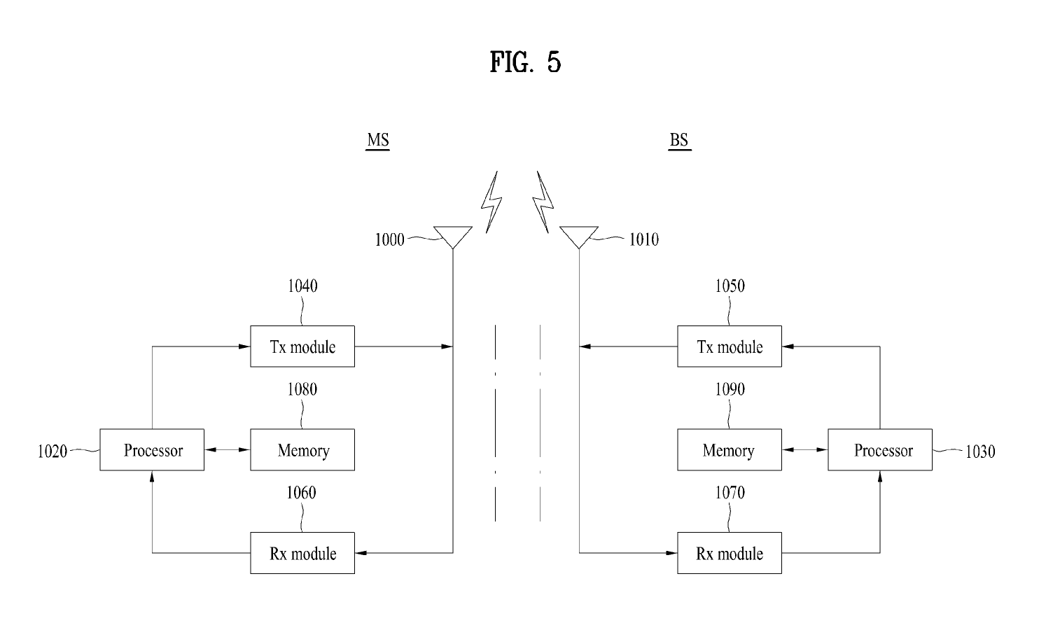

FIG. 5 is a diagram for configurations of mobile and base stations, in which embodiments of the present invention are implemented, according to another embodiment of the present invention.

Referring to FIG. 5, a mobile/base station (AMS/ABS) includes an antenna 1000/1010 capable of transmitting and receiving information, data, signals, messages and/or the like, a transmitting module (Tx module) 1040/1050 transmitting a message by controlling the antenna, a receiving module (Rx module) 1060/1070 receiving a message by controlling the antenna, a memory 1080/1090 storing informations associated with communication with a base station, and a processor 1020/1030 controlling the transmitting module, the receiving module and the memory.

The antenna 1000/1010 externally transmits a signal generated from the transmitting module 1040/1050. And, the antenna 1000/1010 receives a radio signal from outside and then delivers the received radio signal to the receiving module 1060/1070. In case that a multiple-antenna (MIMO) function is supported, at least two antennas can be provided to the mobile/base station.

The processor 1020/1030 generally controls overall operations of the mobile/base station. In particular, the processor 1020 of the base station is able to perform a control function for performing the aforesaid embodiments of the present invention in the VoIP communication, e.g., a function of controlling scheduling using 2 types of CQICH codeword, QoS parameters belonging to one of 2 kinds of categories (GPI_Primary, GPI_Secondary, GrantSize_Primary, and GrantSize_Secondary). And, the processor 1020 of the mobile station is able to control a corresponding VoIP packet transmission and a corresponding SID packet transmission. And, the processor 1020/1030 can have such a hierarchical structure as MAC, PHY and the like.

The transmitting module 1040/1050 performs prescribed coding and modulation on a signal and/or data, which is scheduled by the processor and will be then transmitted externally, and is then able to deliver the coded and modulated signal and/or data to the antenna 1000/1010.

The receiving module 1060/1070 reconstructs the radio signal received externally via the antenna 1000/1010 into original data in a manner of performing decoding and demodulation on the received radio signal and is then able to deliver the reconstructed original data to the processor 1020/1030.

The memory 1080/1090 can store programs for the processing and control of the processor and is able to perform a function of temporarily storing input/output data (e.g., in case of the mobile station, UL grant allocated by the base station, system information, station identifier (STID), a flow identifier (FID), an action time, region allocation information, frame offset information, etc.).

And, the memory 1080/1090 can include at least one of storage media including a flash memory, a hard disk, a multimedia card micro type memory, a memory card type memory (e.g., SD memory, XD memory, etc.), a RAM (random access memory), an SRAM (static random access memory), a ROM (read-only memory), an EEPROM (electrically erasable programmable read-only memory), a PROM (programmable read-only memory), a magnetic memory, a magnetic disk, an optical disk and the like.

Embodiments of the present invention can be implemented using various means. For instance, embodiments of the present invention can be implemented using hardware, firmware, software and/or any combinations thereof. In case of the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

And, it is apparently understandable that an embodiment is configured by combining claims failing to have relation of explicit citation in the appended claims together or can be included as new claims by amendment after filing an application.

### INDUSTRIAL APPLICABILITY

Accordingly, the above description is made centering on IEEE 802.16 series system and is also applicable to 3GPP2 series system in a similar manner.

What is claimed is:

1. A method of allocating a resource, which is allocated to a mobile station by a base station performing VoIP communication with the mobile station, comprising the steps of:
receiving a first type CQICH codeword from the mobile station;
allocating an uplink resource of a first type bandwidth size to the mobile station in each first type interval;
receiving a second type CQICH codeword from the mobile station; and
allocating an uplink resource of a second type bandwidth size to the mobile station,
wherein the first type bandwidth size, the first type interval and the second type bandwidth size are previously set to a bandwidth size for VoIP packet transmission, a VoIP packet transmission interval and a bandwidth size for SID packet transmission, respectively.

2. The method of claim 1, wherein the first type CQICH codeword is used in a talk spurt and the second type CQICH codeword is used in a silence period.

3. The method of claim 1, wherein if an interval for the SID packet transmission is not defined, the base station having received the second type CQICH codeword allocates the uplink resource of the second type bandwidth size to the mobile station once only.

4. The method of claim 1, wherein if an interval for the SID packet transmission is not defined, the base station having received the second type CQICH codeword allocates the uplink resource of the second type bandwidth size to the mobile station with the first type interval.

5. The method of claim 1, wherein the second type interval is previously set as an interval for the SID packet transmission and the base station having received the second type CQICH codeword allocates the uplink resource of the second type bandwidth size to the mobile station with the second type interval.

6. A method of performing VoIP communication, which is performed on a base station by a mobile station, comprising the steps of:
transmitting a first type CQICH codeword to the base station;
transmitting a VoIP packet using an uplink resource of a first type bandwidth size, the uplink resource allocated by the base station in each first type interval;
transmitting a second type CQICH codeword to the base station; and
transmitting an SID packet by receiving an uplink resource of a second type bandwidth size, the uplink resource allocated by the base station,
wherein the first type bandwidth size, the first type interval and the second type bandwidth size are previously set to a bandwidth size for VoIP packet transmission, a VoIP packet transmission interval and a bandwidth size for SID packet transmission, respectively.

7. The method of claim 6, wherein the first type CQICH codeword is used in a talk spurt and the second type CQICH codeword is used in a silence period.

8. The method of claim 6, wherein if an interval for the SID packet transmission is not defined, the mobile station transmits the second type CQICH codeword to the base station for the SID packet transmission each time.

9. The method of claim 6, wherein if an interval for the SID packet transmission is not defined, the mobile station having transmitted the second type CQICH codeword transmits the SID packet by having the uplink resource of the second type bandwidth size allocated by the base station with the first type interval.

10. The method of claim 6, wherein the second type interval is previously set as an interval for the SID packet transmission and the mobile station having transmitted the second type CQICH codeword transmits the SID packet by having the uplink resource of the second type bandwidth size allocated by the base station with the second type interval.
